(19) United States
(12) Patent Application Publication
(10) Pub. No.: US 2024/0068603 A1
(43) Pub. Date: Feb. 29, 2024

(54) COMPOSITE TUBING

(71) Applicant: Cytec Industries Inc., Princeton, NJ (US)

(72) Inventors: James Francis Pratte, Wilmington, DE (US); Daniel Robert Thompson, Heanor (GB)

(73) Assignee: Cytec Industries Inc., Princeton, NJ (US)

(21) Appl. No.: 18/257,864

(22) PCT Filed: Dec. 15, 2021
(86) PCT No.: PCT/EP2021/085983

§ 371 Date: Jun. 15, 2023

Related U.S. Application Data
(60) Provisional application No. 63/125,423, filed on Dec. 15, 2020.

(30) Foreign Application Priority Data
Mar. 3, 2021 (EP) 21160555.5

(51) Int. Cl. F16L 11/08; B32B 1/08; B32B 5/12; B32B 27/08; B32B 27/12; B32B 27/30

(52) U.S. Cl. CPC F16L 11/08; B32B 1/08; B32B 5/12; B32B 27/08; B32B 27/12; B32B 27/304; B32B 2250/05; B32B 2260/023; B32B 2260/046; B32B 2262/106; B32B 2307/704; B32B 2597/00

(57) ABSTRACT

Spoolable tubing suitable for use in the oil industry, and more particularly spoolable composite tubing with the ability to withstand high stress and high cracking resistance.

### RELATED APPLICATIONS

This application claims priority to U.S provisional application U.S. 63/125,423 filed on Dec. 15, 2020 and to European patent application EP 21160555.5 filed on Mar. 3, 2021, the whole content of these applications being incorporated herein by reference for all purposes.

### TECHNICAL FIELD

The present invention relates to tubing suitable for use in the oil industry, and more particularly to spoolable composite tubing with the ability to withstand high stress.

### BACKGROUND ART

Spoolable tubing, that-is-to-say a tubing which can be spooled upon a reel, is commonly used in various oil well operations. Typical oil well operations include running wire line cable down hole with well tools, working over wells by delivering various chemicals down hole, and performing operations on the interior surface of the drill hole. The tubes used are required to be spoolable, so that the tube can be used in conjunction with one well and then transported on a reel to another well location. Steel coiled tubing is typically capable of being spooled because the steel used in the product exhibits high ductility (i.e. the ability to plastically deform). However, the weight of a conventional steel tubing is very high, also when submerged. The top tension is extremely high at large water depths, and accordingly steel tubing of flexible type have only been used in rather shallow water.

Oil & Gas industry is looking for lighter weight tubing for sub-sea transport of crude oil from deep ocean fields to surface ships, which does not suffer from the limitations of steel tubing and is highly resistant to chemicals.

In recent years, fiber reinforced polymer tubing, hereinafter referred to as “composite tubing”, have been proposed as an alternative solution because they are corrosion free and provide a number of benefits, such as higher strength to weight ratio when compared to metallic pipes and the potential to be spoolable making them easier to transport and install than metallic pipes. The basic design of a composite tubing consists of an internal fluid barrier, normally a layer of a thermoplastic material, on which the reinforcement is wound in a continuous process. The reinforcing laminate consists of multiple, counter-wound fiber layers, normally glass or carbon, in a polymeric matrix. The polymeric matrix may comprise a thermoset or a thermoplastic polymer.

It is one object of this invention to provide a spoolable composite tubing in which the polymer matrix of the reinforcing laminate is a thermoplastic material.

Another object of the invention includes providing a composite tubing capable of repeated spooling and bending without suffering fatigue sufficient to cause fracturing and failing of the tube.

Other objects of the invention include providing a spoolable tube capable of carrying corrosive fluids without causing corrosion in the spoolable tube, providing a coiled tube having less weight, and providing a coiled tube capable of withstanding higher internal pressure levels and higher external pressure levels without losing tube integrity.

These and other objects will be apparent from the description that follows.

### SUMMARY OF THE INVENTION

The present invention relates to a composite tubing comprising:
an inner liner of a thermoplastic material, and
a reinforcing laminate surrounding to said inner liner,
   wherein the reinforcing laminate comprises at least two layers:
at least one layer (L1), which is free of reinforcing fibers, and comprises a vinylidene fluoride polymer, and
at least one layer (L2) comprising a vinylidene fluoride polymer and continuous reinforcing fibers.

The inner liner is in contact with the fluid being transported. The reinforcing laminate is typically continuously bonded to the inner liner.

The composite tubing may optionally comprise an external protective layer surrounding the reinforcing laminate.

The composite tubing of the invention is capable of maintaining an open bore configuration while being spooled on a reel.

### BRIEF DESCRIPTION OF THE DRAWING

FIG. 1 shows 90° flexural stress-strain curves for the laminates of Examples 1 to 3 and of Comparative Example 1.

### DETAILED DESCRIPTION OF THE INVENTION

A first object of the invention is a composite tubing comprising:
an inner liner of a thermoplastic material, and
a reinforcing laminate surrounding to said inner liner,
   wherein the reinforcing laminate comprises at least two layers:
at least one layer (L1), free of reinforcing fibers, comprising a vinylidene fluoride polymer, and
at least one layer (L2) comprising a vinylidene fluoride polymer and continuous reinforcing fibers.

For the purpose of the present invention, the term “thermoplastic” is intended to denote polymers and/or compositions that are solid at room or usage temperature, which become soft when heated and become rigid again when they are cooled, without there being an appreciable chemical and physical properties change. Such a definition may be found, for example, in the encyclopedia called Polymer Science Dictionary. Edited by MARK S. M. ALGER. LONDON: ELSEVIER APPLIED SCIENCE, 1989. p. 476.

The indeterminate article “a” in an expression like “a vinylidene fluoride polymer”, is intended to mean “one or more”, or “at least one” unless indicated otherwise.

The use of brackets “( )” before and after names of compounds, symbols or numbers, e.g. “Layer (L1)”, “Layer (L2)”, etc . . . , has the mere purpose of better distinguishing that name, symbol or number from the rest of the text; thus, said parentheses could also be omitted.

Throughout the text, when numerical ranges are indicated, range ends are included.

The expressions “vinylidene fluoride polymer” or “VDF polymer” are equivalent and used within the frame of the present invention for designating polymers essentially made of recurring units, more than 50% by moles of said recurring units being derived from vinylidene fluoride (VDF).

Vinylidene fluoride polymers suitable for the tubing of the invention are polymers comprising:
(a) at least 60% by moles, preferably at least 75% by moles, more preferably 85% by moles of recurring units derived from vinylidene fluoride (VDF);
(b) optionally from 0.1 to 15%, preferably from 0.1 to 12%, more preferably from 0.1 to 10% by moles of recurring units derived from a fluorinated monomer different from VDF; and
(c) optionally from 0.1 to 5% by moles, preferably 0.1 to 3% by moles, more preferably 0.1 to 1% by moles of recurring units derived from one or more hydrogenated co-monomer(s), wherein for “hydrogenated co-monomer” it is intended a non-halogenated co-monomer,
all the aforementioned % by moles being referred to the total moles of recurring units of the VDF polymer.

The said fluorinated monomer different from VDF is advantageously selected in the group consisting of vinyl fluoride (VF 1); trifluoroethylene (VF 3); chlorotrifluoroethylene (CTFE); 1,2-difluoroethylene; tetrafluoroethylene (TFE); hexafluoropropylene (HFP); perfluoro(alkyl)vinyl ethers, such as perfluoro(methyl)vinyl ether (PMVE), perfluoro(ethyl) vinyl ether (PEVE) and perfluoro(propyl)vinyl ether (PPVE); perfluoro(1,3-dioxole); perfluoro(2,2-dimethyl-1,3-dioxole) (PDD). Preferably, the possible additional fluorinated monomer is chosen from chlorotrifluoroethylene (CTFE), hexafluoroproylene (HFP), trifluoroethylene (VF₃) and tetrafluoroethylene (TFE).

The choice of the said hydrogenated co-monomer(s) is not particularly limited; alpha-olefins, (meth)acrylic monomers, vinyl ether monomers, styrenic monomers may be used.

Among suitable VDF polymers mention may be made of polymers comprising:
(a′) at least 60% by moles, preferably at least 75% by moles, more preferably 85% by moles of vinylidene fluoride (VDF);
(b′) optionally from 0.1 to 15%, preferably from 0.1 to 12%, more preferably from 0.1 to 10% by moles of a fluorinated co-monomer chosen among vinylfluoride (VF 1), chlorotrifluoroethylene (CTFE), hexafluoropropene (HFP), tetrafluoroethylene (TFE), trifluoroethylene (TrFE) and mixtures therefrom; and
(c′) optionally from 0.1 to 5%, by moles, preferably 0.1 to 3% by moles, more preferably 0.1 to 1% by moles, based on the total amount of monomers (a′) and (b′), of one or more fluorinated or hydrogenated co-monomer(s).

Non limiting examples of VDF polymers useful in the tubing of the present invention, are for instance homo-polymers of VDF, VDF/TFE copolymers, VDF/TFE/HFP co-polymers, VDF/TFE/CTFE co-polymers, VDF/TFE/TrFE co-polymers, VDF/CTFE co-polymers, VDF/HFP co-polymers, VDF/TF E/HFP/CTFE co-polymers, VDF/TFE/perfluorobutenoic acid co-polymers, VDF/TFE/maleic acid co-polymers and the like.

The polymer (VDF) may be semi-crystalline or amorphous.

The term “semi-crystalline” is hereby intended to denote a polymer (VDF) having a heat of fusion of from 10 to 90 J/g, preferably of from 30 to 60 J/g, more preferably of from 35 to 55 J/g, as measured according to ASTM D3418-08.

The term “amorphous” is hereby intended to denote a polymer (VDF) having a heat of fusion of less than 5 J/g, preferably of less than 3 J/g, more preferably of less than 2 J/g as measured according to ASTM D-3418-08.

The polymer (VDF) is preferably semi-crystalline.

The Inner Liner

The inner liner acts as a barrier against the pressurised oil/gas flow. It protects the reinforced laminate from exposure to wear, abrasion, chemicals, heat etc. The term “liner” is used herein to refer to a tubing.

The inner liner is made of a thermoplastic material. In some embodiments, it is made of a thermoplastic material capable to withstand temperatures in the order of 100 to 200° C. Suitable thermoplastic materials for the inner liner may be selected from the group consisting of polyamides, e.g. PA11, PA12, PA6,12, high density polyethylene (HDPE), crosslinked polyethylene (PEX), polypropylene, vinylidene fluoride polymers, etylene tetrafluoroethylene copolymers, polyetherether ketone polymers (PEEK), polyphenylene sulfide, polyethersulfone and mixtures thereof.

In one embodiment, the inner liner comprises a vinylidene fluoride polymer.

In a preferred embodiment, the inner liner comprises a mixture of at least one VDF homo-polymer and at least one VDF co-polymer selected from the group consisting of VDF co-polymers comprising from 0.1 to 15 mol. %, preferably from 0.1 to 12 mol. %, more preferably from 0.1 to 10 mol. % of a fluorinated co-monomer chosen among vinylfluoride (VF 1), chlorotrifluoroethylene (CTFE), hexafluoropropene (HFP), tetrafluoroethylene (TFE), trifluoroethylene (TrFE) and mixtures therefrom.

The inner liner thickness may be from 5.0 to 15.0 mm, for example from 6.0 to 14.0 mm or from 7.0 to 13.0 mm, ±0.5 mm.

The inner liner may be obtained by extrusion.

The Reinforcing Laminate

The reinforcing laminate comprises at least two layers: at least one layer which is free of continuous reinforcing fibers comprising a vinylidene fluoride polymer [Layer (L1)], and at least one layer comprising a vinylidene fluoride polymer and continuous reinforcing fibers [Layer (L2)].

Layer (L1) comprises a vinylidene fluoride polymer as defined above.

In addition to the vinylidene fluoride polymer, or advantageously the VDF homo-polymer, the layer (L1) may optionally comprise additional components, for example additive(s) and/or reinforcing agent(s). When the layer (L1) comprises reinforcing agent(s), such agents are however not continuous reinforcing fibers, as defined hereafter.

The optional additives may be selected from the group consisting of (i) colorants such as dyes, (ii) pigments such as titanium dioxide, zinc sulfide and zinc oxide, (iii) light stabilizers, e.g., UV stabilizers, (iv) heat stabilizers, (v) antioxidants, (vi) acid scavengers, (vii) processing aids, (viii) nucleating agents, (ix) internal lubricants and/or external lubricants, (x) flame retardants, (xi) smoke-suppressing agents, (x) anti-static agents, (xi) anti-blocking agents, (xii) conductivity additives such as carbon black and carbon nanofibrils, (xiii) plasticizers, (xiv) flow modifiers, (xv) extenders, and (xvii) flow aids, and mixtures thereof.

When present, the weight % of the optional additives and/or reinforcing agents advantageously ranges from 0.05 wt. % to 5 wt. %, based on the total weight of the overall composition, for example from 0.1 wt. % to 4 wt. % or from 0.2 wt. % to 3 wt. %.

Advantageously, the layer (L1) comprises a VDF homo-polymer. Layer (L1) may consist essentially of a VDF homo-polymer.

For the purpose of the present invention, the expression “consisting essentially of” is to be understood to mean that any additional component different from those listed, is present in an amount of at most 1 wt. %, preferably at most 0.5 wt. %, based on the total weight of a given composition, so as not to substantially alter the properties of the composition.

The layer (L1) may have a thickness ranging from 20 to 150 μm, preferably from 30 to 140 μm or from 40 to 130 μm.

The layer (L2) comprises a vinylidene fluoride polymer as above defined, as well as continuous reinforcing fibers.

As used herein, the term “fiber” has its ordinary meaning as known to those skilled in the art and may include one or more fibrous materials adapted for the reinforcement of composite structures, i.e., a “reinforcing fiber”. The term “fiber” is used herein to refer to fibers that have a length of at least 0.5 mm. The expression “continuous fibers” identifies fibers having a length of greater than or equal to 3 mm, more typically greater than or equal to 10 mm and an aspect ratio of greater than or equal to 500, more typically greater than or equal to 5,000.

The fibers may be organic fibers, inorganic fibers or mixtures thereof. Suitable fibers for use as the reinforcing fiber component include, for example, carbon fibers, graphite fibers, glass fibers, such as E glass fibers, ceramic fibers such as silicon carbide fibers, synthetic polymer fibers such as aromatic polyamide fibers, polyimide fibers, high-modulus polyethylene (PE) fibers, polyester fibers and polybenzoxazole fibers such as poly-p-phenylene-benzobisoxazole (PBO) fibers, aramid fibers, boron fibers, basalt fibers, quartz fibers, alumina fibers, zirconia fibers and mixtures thereof.

In one embodiment, the fibers comprise carbon fibers, glass fibers, or both carbon fibers and glass fibers.

In some embodiments, the fibers include at least one carbon fiber. As used herein, the term “carbon fiber” is intended to include graphitized, partially graphitized, and ungraphitized carbon reinforcing fibers, as well as mixtures thereof. The carbon fibers can be obtained by heat treatment and pyrolysis of different polymer precursors such as, for example, rayon, polyacrylonitrile (PAN), aromatic polyamide or phenolic resin; carbon fibers may also be obtained from pitchy materials. The term “graphite fiber” is intended to denote carbon fibers obtained by high temperature pyrolysis (over 2000° C.) of carbon fibers, wherein the carbon atoms place in a way similar to the graphite structure. The carbon fibers are preferably chosen from the group consisting of PAN-based carbon fibers, pitch based carbon fibers, graphite fibers, and mixtures thereof. The carbon fibers may be sized or un-sized. In one embodiment, the carbon fibers are sized carbon fiber. The appropriate size for a carbon fiber is a size that is thermally compatible with anticipated processing temperatures and may be selected from, for example, polyamideimide, polyetherimide, and polyimide polymers, each of which may optionally include additives, e.g., nucleating agents, to improve the interfacial properties of the fiber.

In some embodiments, the continuous reinforcing fibers include at least one glass fiber. Glass fibers may have a circular cross-section or a non-circular cross-section (such as an oval or rectangular cross-section). When the glass fibers used have a circular cross-section, they preferably have an average glass fiber diameter of 3 to 30 μm, with a particularly preferred average glass fiber diameter of 5 to 12 μm. Different types of glass fibers with a circular cross-section are available on the market depending on the type of the glass they are made of. One may notably cite glass fibers made from E- or S-glass.

In some embodiments, the glass fiber is standard E-glass material with a non-circular cross section. In some embodiments, the polymer composition includes S glass fibers with a circular cross-section.

Fibers may be included in the layer (L2) in a number of different forms or configurations. Continuous fibers may adopt any of unidirectional, multi-dimensional, non-woven, woven, knitted, non-crimped, web, stitched, wound, and braided configurations, as well as swirl mat, felt mat, and chopped mat structures. In some embodiments, continuous fibers suitable for use in connection with the tubing of the present invention may be in the form of rovings or tows (including individual tows or rovings, tow/roving bundles or spread tows). Rovings generally refer to a plurality of continuous untwisted filaments of fiber, e.g., glass fiber, optionally reinforced with a chemical binding material. Similarly, tows generally refer to a plurality of continuous individual filaments, e.g., carbon filaments, optionally with an organic coating.

In some embodiments, fibers suitable for use in connection with the tubing of the present invention may be in the form of unidirectional tapes. As used herein, “tape” means a strip of material with longitudinally extending fibers that are aligned along a single axis of the strip material. Tapes are advantageous because they can be used in hand or automated layup processes in order to create a composite material having relatively complex shape. In one embodiment, the layer (L2) comprises a unidirectional continuous-fiber reinforced tape.

Overall, the continuous reinforcing fibers may constitute at least 15% by volume of the total volume of the layer (L2). Typically, the continuous reinforcing fibers are at least 20%, at least 25%, even at least 30% of the total volume of the layer (L2). The continuous reinforcing fibers are no more than 80%, no more than 75%, even no more than 70% by volume of the total volume of the layer (L2). The continuous reinforcing fibers may conveniently represent from 20% to 75%, from 25% to 70%, from 25% to 65% and even from 30% to 60% of the total volume of the layer (L2). The vinylidene fluoride polymer may then represent the remainder of the volume of the layer (L2).

The layer (L2) may preferably have a thickness ranging from 100 μm to 600 μm, preferably from 150 to 550 μm or from 200 to 500 μm.

Structure of the Reinforcing Laminate

Reinforcing laminate comprises at least one layer (L1) and at least one layer (L2) as above detailed. The reinforcing laminate of the present invention may comprises more than one layer (L1) and more than one layer (L2).

The total number of layers (L1)+(L2) in the reinforcing laminate may be any integer number in the range from 2 to 40, from 2 to 30, from 3 to 30. In an embodiment of the invention, the reinforcing laminate has a total number of layers (L1)+(L2) from 4 to 20.

The reinforcing laminate may or may not contain the same number of layers (L1) and layers (L2). In one, preferred embodiment, the number of layers (L1) is equal or less than the number of layers (L2).

When more than one layer (L1) and/or more than one layer (L2) are present in the reinforcing laminate, said layers may be arranged according to any configuration.

In one embodiment, the reinforcing laminate has a configuration comprising alternating layers. As an example, in a reinforcing laminate comprising a total of 8 layers, 4 of which being layers (L1) and 4 of which being layers (L2), an alternating configuration may be as follows:
(L1)/(L2)/(L1)/(L2)/(L1)/(L2)/(L1)/(L2).

Other non-limiting alternating configurations, comprising an uneven number of layers (L1)+(L2) are for instance:
(L2)/(L1)/(L2)/(L1)/(L2)/(L1)/(L2);
(L2)/(L1)/(L2)/(L1)/(L2)/(L1)/(L2)/(L1)/(L2).

In another embodiment, the layers (L1) and layers (L2) are arranged in a non-alternating configuration.

In one aspect of said embodiment, the reinforcing laminate may comprise one or more contiguous layers (L2), at least 2 contiguous layers (L1) followed by at least 2 alternating layers (L2) and (L1).

Non-limiting examples of configurations according to this aspect of the invention are for instance:
(L2)/(L1)/(L1)/(L2)/(L1);
(L2)/(L2)/(L1)/(L1)/(L2)/(L1);
(L2)/(L2)/(L2)/(L1)/(L1)/(L2)/(L1)/(L2);
(L2)/(L2)/(L2)/(L1)/(L1)/(L2)/(L1)/(L2)/(L1)/(L2);
(L2)/(L2)/(L2)/(L2)/(L1)/(L1)/(L2)/(L1)/(L2)/(L1)/(L2)/(L1)/(L2).

Configurations comprising 1 to 5 contiguous layers (L2), 2 contiguous layers (L1) and 2 to 10 alternating layers (L2) and (L1) have been found to provide advantageous results in terms of mechanical property of the laminate with respect to reinforcing laminate structures containing only Layers (L2).

In another aspect, the reinforcing laminate may comprise one or more contiguous layers (L2), at least 2 contiguous layers (L1), one or more contiguous layers (L2), one or more contiguous layers (L1) and one or more contiguous layers (L2).

Non-limiting examples of configurations according to this aspect of the invention are for instance:
(L2)/(L2)/(L1)/(L1)/(L2)/(L1)/(L2);
(L2)/(L2)/(L2)/(L1)/(L1)/(L2)/(L2)/(L1)/(L2);
(L2)/(L2)/(L2)/(L1)/(L1)/(L2)/(L2)/(L1)/(L1)/(L2)/(L2);
(L2)/(L2)/(L2)/(L2)/(L1)/(L1)/(L2)/(L2)/(L1)/(L1)/(L2)/(L2).

Configurations comprising 1 to 5 contiguous layers (L2), 2 contiguous layers (L1), 2 contiguous layers (L2), 2 contiguous layers (L1), and 2 to 10 contiguous layers (L2) have been found to provide advantageous results in terms of mechanical property of the laminate with respect to reinforcing laminate structures containing only Layers (L2).

Without wishing to be bound by theory, it is believed that in addition to improving certain mechanical properties, layer (L1) acts as crack stoppers, hence reducing the propagation of cracks through the reinforcing laminate.

Other Layers in the Composite Tubing

The composite tubing may optionally comprise other layers in addition to the inner liner and the reinforcing laminate.

The composite tubing may advantageously comprise an external protective layer surrounding the reinforcing laminate. The external layer protects the reinforced laminate from outer exposure of wear, abrasion, chemicals, heat etc. Each layer of the tubing is designed to be just sturdy enough to tolerate the stress it is exposed to at its own position within the tubing.

The external layer can be a polymer, thermoset or thermoplastic, an elastomer and/or a composite, where the composite includes a filled polymer composite, a polymer/metallic composite, and/or a metal. In some embodiments, the external layer can include one or more of high density polyethylene (HDPE), a cross-linked polyethylene (PEX), a vinylidene fluoride polymer, a polyamide, polyethylene terphthalate, polyphenylene sulfide and/or a polypropylene. Typical thickness of the external layer may range from 4 to 15 mm, from 4 to 10 mm.

Manufacture of the Composite Tubing

The composite tubing of the invention may be manufactured according to techniques known to the person skilled in the art.

The inner liner is typically prepared by means of extrusion.

The reinforcing laminate may typically be prepared by laminating together, in the appropriate configuration, the layers (L1) and the layers (L2). The layers (L2) may be arranged in such a way that the continuous fibers in each layer (L2) is at an appropriate angle with respect to the continuous fiber in other layers (L2) to maximise the resistance of the composite tubing to the internal and external pressures and mechanical stresses generated when in use.

Alternatively, the continuous fibers in the layers (L2) are aligned in the same direction.

The composite tubing according to the invention can for example be manufactured by winding onto a thermoplastic pipe, i.e. the inner liner in the finished tubing, the reinforcing laminate as above detailed.

A seamless structure can be achieved in this manufacturing method by fusing by means of heat the matrix polymer of the reinforcing laminate and/or the thermoplastic inner layer, either entirely or in part, and then by interconnecting the layers in molten state.

The reinforcing laminate may be wound onto the inner liner by winding it at a winding angle of 0°-180°, typically 60°-140°, even 70°-110°, 80°-100°. The selection of the winding angle depends on the intended use of the tubing and the stresses it will be subjected to. The angle is selected so that the capacity of the tubing to bear axial and radial loads will be optimal.

After the winding or other manufacturing method, the thermoplastic composite tubing may be coated with an external layer, such as a layer of a thermoplastic or a thermosetting polymer and/or some other coating material which will adhere to the outermost layer and the purpose of which is to shield the thermoplastic composite pipe from impact, radiation, thermal action, burning, cooling action, corrosion, and/or other environmental effects.

The manufacture of the composite tubing can be carried out advantageously by using the so-called prepreg method by connecting onto the inner liner a reinforcing laminate in the form of a tape. The reinforcing laminate in tape-form of a suitable width, selected according to the diameter of the core pipe and the selected winding angle, is directed from a roll onto the circumference of the rotating inner liner. The seamless fusion of the reinforcing laminate and the thermoplastic inner liner is effected by heating the reinforcing laminate to its softening or melting point before directing it onto the surface of the inner liner. In addition, the surface of the inner liner may also be heated at the fusion point so that the outermost surface of the liner will be at a temperature at which softening and/or melting may occur. The fusion may also be ensured by pressure molding the pipe at the fusion point by means of a pressure roll or the like.

In the tubing of the present invention, the reinforcing laminate may be integrally attached to the inner liner. The advantage of a bonded liner is that, under certain operating conditions, the external surface of the tubing may be subjected to higher pressure than the interior of the tubing. If the liner is not bonded to the reinforcing laminate, the external pressure can force the liner to buckle and separate from the reinforcing laminate such that the liner collapses.

Should the disclosure of any patents, patent applications, and publications which are incorporated herein by reference conflict with the description of the present application to the extent that it may render a term unclear, the present description shall take precedence.

### EXAMPLES

The disclosure is now described in more detail with reference to the following examples, whose purpose is merely illustrative and not intended to limit the scope of the disclosure.

Raw Materials
Layer (L1): 0.25 thick films of Solef® 1010, a vinylidene homopolymer
Layer (L2): Evolite™ F1160, available from Solvay, a unidirectional tape comprising continuous carbon fibers and a semicrystalline vinylidene polymer.

### Examples 1 to 3—Comparative Example 1

Reinforcing laminates were prepared by laying up layers (L1) or (L2) into the following test laminate lay-ups:

| | Layer configuration |
|---|---|
| Example 1 | (L2)/(L1)/(L2)/(L1)/(L2)/(L1)/(L2)/(L1)/(L2)/(L1)/(L2)/(L1)/ |
| | (L2)(L1)(L2) |
| Example 2 | (L2)/(L2)/(L2)/(L2)/(L1)/(L1)/(L2)/(L2)/(L1)/(L1)/(L2)/(L2) |
| Example 3 | (L2)/(L2)/(L2)/(L2)/(L1)/(L1)/(L2)/(L1)/(L2)/(L1)/(L2)/(L1)/ |
| | (L2) |
| Comp. | (L2)/(L2)/(L2)/(L2)/(L2)/(L2)/(L2)/(L2) |
| Example 1 | |

The lay-ups were vacuum bagged and then autoclaved using a straight ramp heating and cooling cycle while applying 635-735 mm Hg vacuum. The heat up ramp rate from 23° C. to the maximum process temperature was 2-5° C./min while the cooling rate was 2-7° C./min from the maximum temperature back to room temperature ambient (23° C.). When the temperature reached the maximum temperature (210° C.) then 0.34 MPa of pressure was applied and held at the maximum temperature and pressure for 15 minutes before cooling under the applied pressure. The applied pressure was held on the lay-up until it had cooled below 93° C.

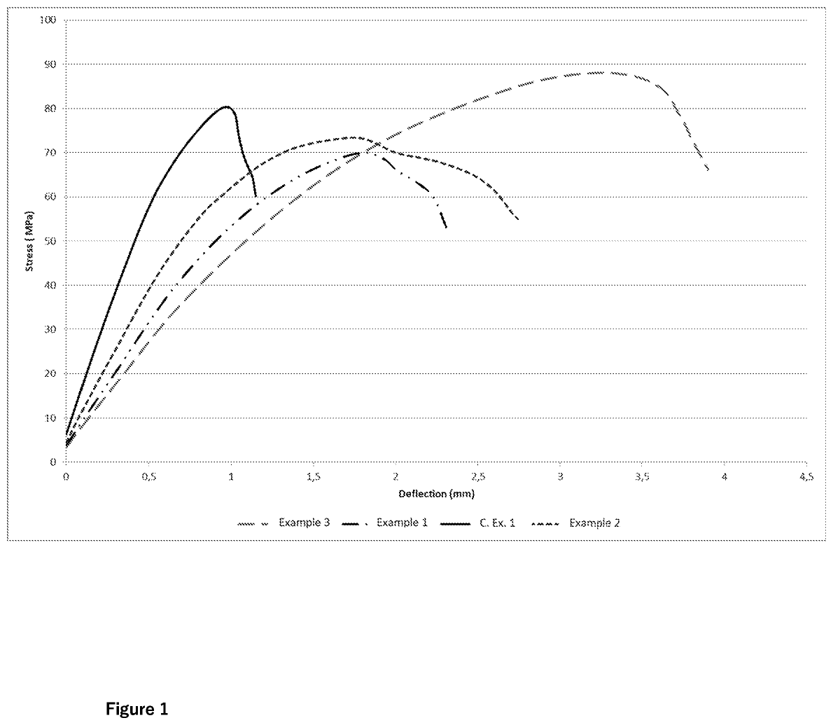

The 90° flexural strength of the samples was determined at 23° C. according to ASTM D790. The results are reported in FIG. 1.

The curves in FIG. 1 show that laminates of Examples 1 to 3 have better resistance to flexural strain than a laminate consisting only of layers (L2). The improved flexural resistance corresponds to a better resistance of the laminates according to Examples 1 to 3 to the stresses at the conditions of operation of the composite tubing.

1. A composite tubing comprising:
an inner liner of a thermoplastic material, and
a reinforcing laminate surrounding the inner liner,
wherein the reinforcing laminate comprises at least two layers:
at least one layer (L1), which is free of reinforcing fibers, such layer comprising a vinylidene fluoride polymer, and
at least one layer (L2) comprising a vinylidene fluoride polymer and continuous reinforcing fibers.

2. The composite tubing of claim 1, further comprising an external protective layer surrounding the reinforcing laminate.

3. The composite tubing of claim 1, wherein the continuous reinforcing fibers in layer (L2) are selected from the group consisting of carbon fibers, glass fibers and mixture thereof.

4. The composite tubing of claim 1, wherein the continuous reinforcing fibers represent at least 15% by volume of a total volume of layer (L2).

5. The composite tubing of claim 1, wherein the vinylidene fluoride polymer in layer (L1) and/or in layer (L2) is a vinylidene fluoride homopolymer.

6. The composite tubing of claim 1, wherein the reinforcing laminate has a total number of layers [(L1)+(L2)] comprised between 5 and 20.

7. The composite tubing of claim 1, wherein the reinforcing laminate has a configuration comprising alternating layers (L1) and layers (L2).

8. The composite tubing of claim 1, wherein the reinforcing laminate comprises one or more contiguous layers (L2), at least 2 contiguous layers (L1) followed by at least 2 alternating layers (L2) and (L1).

9. The composite tubing of claim 8, wherein the reinforcing laminate comprises 1 to 5 contiguous layers (L2), 2 contiguous layers (L1) and 2 to 10 alternating layers (L2) and (L1).

10. The composite tubing of anyone of claim 1, wherein the reinforcing laminate comprises one or more contiguous layers (L2), at least 2 contiguous layers (L1), one or more contiguous layers (L2), one or more contiguous layers (L1) and one or more contiguous layers (L2).

11. The composite tubing of claim 10, wherein the reinforcing laminate comprises 1 to 5 contiguous layers (L2), 2 contiguous layers (L1), 2 contiguous layers (L2), 2 contiguous layers (L1), and 2 to 10 contiguous layers (L2).
